(19) United States
(12) Patent Application Publication
(10) Pub. No.: US 2021/0348770 A1
(43) Pub. Date: Nov. 11, 2021

(54) KITCHEN VENTILATION SYSTEM

(71) Applicants: BSH Home Appliances Corporation, Irvine, CA (US); BSH Hausgeräte GmbH, Munich (DE)

(72) Inventors: Garrett Bentley, Knoxville, TN (US); Sean Scott, Tulsa, OK (US); Prerna Srivastava, Cerritos, CA (US)

(21) Appl. No.: 16/868,582

(22) Filed: May 7, 2020

(51) Int. Cl. F24C 15/20; B01D 46/10; B01D 46/00

(52) U.S. Cl. CPC F24C 15/20; F24C 15/2071; B01D 2279/35; B01D 46/0043; B01D 46/10

(57) ABSTRACT

The present disclosure describes a kitchen ventilation system to be installed in an opening in a wall, including a removable panel and a fan. The removable panel is disposed within an inner perimeter of the opening such that at least one airflow gap is formed between an outer perimeter of the panel and the inner perimeter of the opening and the fan is in fluid communication with the opening in the wall. The removable panel comprises a planar expanse and a raised lip around the outer perimeter, such that the panel is configured to hold one or more wall covering materials secured thereon.

### FIELD

This disclosure relates to systems and methods for ventilation. More specifically, the disclosed embodiments relate to kitchen ventilation systems.

### INTRODUCTION

A ventilation system is an important addition to any kitchen, commercial or residential. The ventilation, filtration, and exhaustion of fumes, smoke, steam and the like provides a measured increase in the quality of life of a kitchen chef. However, existing ventilation systems can be obtrusive and unattractive, sometimes clashing with the rest of the kitchen's decor.

### SUMMARY

The present disclosure provides systems, apparatuses, and methods relating to unobtrusive and easily-concealed kitchen ventilation systems.

In some embodiments, a ventilation system of the present disclosure may include: an opening in a wall; a removable panel disposed within an inner perimeter of the opening, such that at least one airflow gap is formed between an outer perimeter of the panel and the inner perimeter of the opening; and a fan in fluid communication with the opening in the wall, wherein the fan is configured to move air through the at least one airflow gap; wherein the removable panel comprises a planar expanse and a raised lip around the outer perimeter, such that the panel is configured to hold one or more first wall covering materials secured thereon.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a front view of a ventilation system in accordance with the present disclosure.

FIG. 2 is a front view of another ventilation system in accordance with the present disclosure.

FIG. 3 is a front view of another ventilation system in accordance with the present disclosure.

FIG. 4 is a front view of another ventilation system in accordance with the present disclosure.

FIG. 5 is a side profile view of a front panel of a ventilation system in accordance with the present disclosure.

FIG. 6 is another side profile view of a front panel of a ventilation system.

FIG. 7 depicts a ventilation system in an externally exhausting configuration.

FIG. 8 depicts a ventilation system in another externally exhausting configuration.

FIG. 9 depicts a ventilation system in another externally exhausting configuration.

FIG. 10 depicts a ventilation system in another externally exhausting configuration.

FIG. 11 depicts a ventilation system in a recirculating configuration.

FIG. 12 depicts a ventilation system in another recirculating configuration.

FIG. 13 depicts a ventilation system in another recirculating configuration.

FIG. 14 depicts a ventilation system in another recirculating configuration.

FIG. 15 depicts a hinge and latching mechanism for use with a ventilation system.

FIG. 16 depicts an example of a removable front panel for use with a ventilation system.

FIG. 17 depicts a peg hinge and latching mechanism for use with a ventilation system.

### DETAILED DESCRIPTION

Various aspects and examples of a semi-concealed kitchen ventilation system are described below and illustrated in the associated drawings. Unless otherwise specified, a ventilation system in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections A and B, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

“Coupled” means connected, either permanently or releasably, whether directly or indirectly through intervening components.

“Resilient” describes a material or structure configured to respond to normal operating loads (e.g., when compressed) by deforming elastically and returning to an original shape or position when unloaded.

“Rigid” describes a material or structure configured to be stiff, non-deformable, or substantially lacking in flexibility under normal operating conditions.

“Elastic” describes a material or structure configured to spontaneously resume its former shape after being stretched or expanded.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (Al) accelerators, digital signal processors (DSPs), and/or any other suitable combination of logic hardware.

A “controller” or “electronic controller” includes processing logic programmed with instructions to carry out a controlling function with respect to a control element. For example, an electronic controller may be configured to receive an input signal, compare the input signal to a selected control value or setpoint value, and determine an output signal to a control element (e.g., a motor or actuator) to provide corrective action based on the comparison. In another example, an electronic controller may be configured to interface between a host device (e.g., a desktop computer, a mainframe, etc.) and a peripheral device (e.g., a memory device, an input/output device, etc.) to control and/or monitor input and output signals to and from the peripheral device.

Directional terms such as “up,” “down,” “vertical,” “horizontal,” and the like should be understood in the context of the particular object in question. For example, an object may be oriented around defined X, Y, and Z axes. In those examples, the X-Y plane will define horizontal, with up being defined as the positive Z direction and down being defined as the negative Z direction.

“Providing,” in the context of a method, may include receiving, obtaining, purchasing, manufacturing, generating, processing, preprocessing, and/or the like, such that the object or material provided is in a state and configuration for other steps to be carried out.

### Overview

In general, a ventilation system of the present disclosure includes a recessed housing integrated into a wall or ceiling. The housing of the ventilation system is configured to sit inside the structural framing of the wall, such that a peripheral lip of the housing is disposed substantially coplanar with an outermost layer of the wall (i.e., the drywall, tiling, façade, etc.). A front panel is configured to sit within the housing such that the front panel is also coplanar with the outmost layer of the wall.

The housing and front panel are configured such that the outer lip of the housing circumscribes the periphery of the front panel and leaves a gap therebetween. In some examples, the front panel and housing is substantially rectangular, and the gap is disposed on all four sides of the panel. In some examples, the gap may be disposed only on the top, the bottom, either side, or, alternatively, any combination thereof. In some examples, the panel may be triangular, oval, trapezoidal, or otherwise shaped.

Ventilation systems of the present disclosure include a fan (AKA blower) configured to draw air from the kitchen into the housing of the ventilation system through the gap described above. In general, the ventilation system may be either recirculating or externally exhausting. A recirculating ventilation system draws air in from the kitchen through a first portion of the gap and redirects it back out into the kitchen through a second portion of the gap. An externally exhausting ventilation system draws air in from the kitchen and directs it through a duct to an external vent disposed outside the kitchen, e.g., outside of the building.

Ventilation systems of the present disclosure include a filter system disposed within the housing. The filter system may comprise a single filter or a plurality of filters and/or filter layers disposed in the airflow path. The filter system may be accessible by the user e.g., by displacement or removal of the front panel. Air is drawn through the filter by the blower, thereby removing particulates/contaminates from the air. The air is then either directed back into the kitchen (e.g., in a recirculating system), or out of the kitchen/building (e.g., in an externally venting system).

In some examples, ventilation systems include electronics configured to monitor the filter and airflow of the ventilation system. For example, a timer may be reset by the user when a new filter is placed in the ventilation system, to track and indicate the age of the current filter. In some examples, an air flow sensor is configured to measure the air flow of the ventilation system in real-time. Data from the electronic monitoring system may be retrieved through a user interface (e.g., of the ventilation system) or transmitted to an application (e.g., on a personal computer or smartphone associated with the user).

### Examples, Components, and Alternatives

The following sections describe selected aspects of ventilation systems of the present disclosure, as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Ventilation System

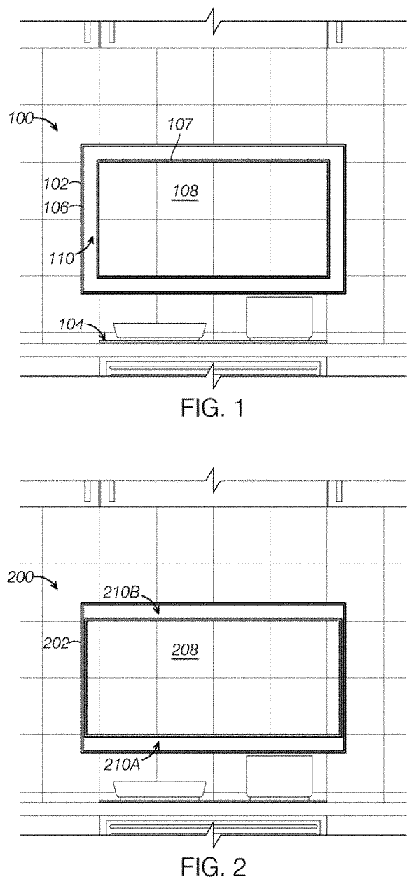

As shown in FIGS. 1-17, this section describes examples of the ventilation systems described above, configured to be hidden within a wall of a kitchen behind the cooktop and integrated into the backsplash of the kitchen wall.

In some examples, the ventilation systems described below are recirculating ventilation systems (i.e., air is drawn into the system and returned to the kitchen). In other examples, the ventilation systems described below are externally exhausting ventilation systems (i.e., air is drawn into the system and ducted to an environment exterior to the room, home, or building). A more detailed description of these two examples is provided below.

Each of the example ventilation systems described below are similarly numbered, for example, a ventilation system 100 includes a housing 102 and, likewise, a ventilation system 200 includes a housing 202. For any given ventilation system described below, components share similar features with similarly numbered components unless stated otherwise.

As shown in FIG. 1, a housing 102 of ventilation system 100 is configured to be disposed within a wall (e.g., a backsplash) adjacent a cooktop 104 (e.g., a cooking range) such that a peripheral lip 106 of the housing 102 is disposed substantially coplanar with an outermost layer of the wall (i.e., the drywall, tiling, façade, etc.). A front panel 108 having a peripheral panel lip 107 is disposed within housing 102, such that panel lip 107 of front panel 108 is coplanar with lip 106 and the outmost layer of the wall.

Housing 102 and front panel 108 are configured such that lip 106 of the housing circumscribes the front panel, leaving a gap 110 therebetween. In the current example, front panel 108 and housing 102 are substantially rectangular. Portions of gap 110 may be utilized by ventilation system 100 for air intake. Similarly, portions of gap 110 may be utilized by ventilation system 100 for air exhaust. Gap 110 may have any suitable dimensions configured to facilitate adequate airflow. For example, gap 110 may be between 0.25 inches and 6 inches. In some examples, gap 110 does not exceed 25% of a width of panel 108 on any given side.

The removable front panel is designed such that standard or custom wall covering, e.g., custom backsplash material (tile, granite, metal, glass, etc.), may be mounted to the panel to match the surrounding wall or backsplash, or to create a specific design contrast. This backsplash material may be mounted by fastening from the rear, or by using an adhesive such as those designed specifically for mounting tile, or other adhesives specific to the application.

As shown in FIG. 1, gap 110 may be disposed on all four sides of panel 108. In this example, panel 108 may be proportionally similar to lip 106, such that gap 110 maintains a same or similar width on all four sides of panel 108. This configuration enables proportional airflow on all sides of panel 108, either during intake or exhaust. This configuration may be advantageous in an externally exhausting ventilation system, where gap 110 functions entirely for air intake.

As shown in FIG. 2, a panel 208 may be configured such that a gap 210 comprises a bottom gap 210A at the bottom portion of panel 208 and a top gap 2108 at the top portion of panel 208. In this example, the distance between the two sides of panel 208 and a lip 206 is reduced or eliminated, such that minimal airflow is allowed through the sides.

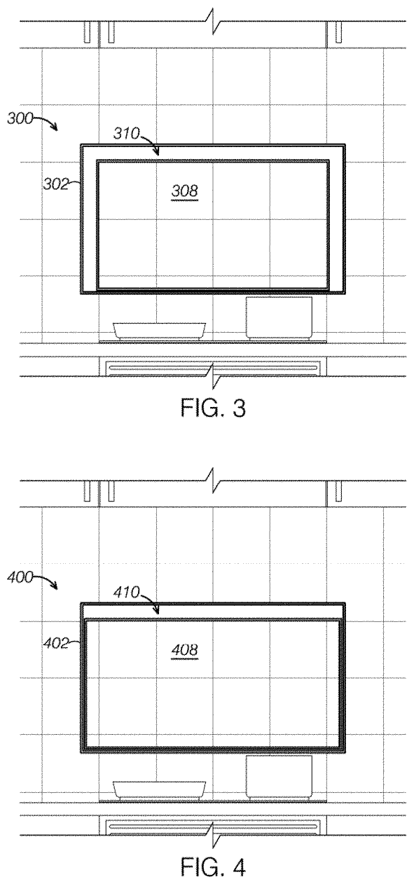

FIGS. 3 and 4 depict further examples of front panels and gaps. Namely, in the example shown in FIG. 3, a front panel 308 may be configured such that a gap 310 is present at the sides and the top, but the bottom gap is closed. FIG. 4 depicts an example wherein a gap 410 is only meaningfully present at the top of a front panel 408.

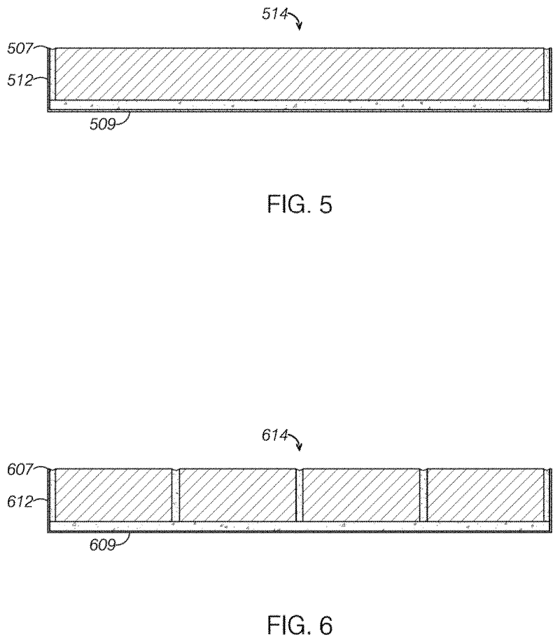

Turning to the sectional side views of FIGS. 5 and 6, all of the front panels described herein include a panel housing 512 and a decorative face 514. Panel housing 512 comprises a peripheral panel lip 507 and a planar expanse 509. Decorative face 514 may include any suitable wall covering or other material configured to match a covering, pattern, and/or decoration of the surrounding wall. Adhesive may be disposed between decorative face 514 and planar expanse 509 to affix the face to housing 512. In some examples, grout is disposed between the periphery of face 514 and panel lip 507 (and/or elsewhere) to match a pattern of the wall.

As depicted in FIG. 6, all of the front panels described herein may alternatively include a decorative face 614, which may include a plurality of sub-pieces (e.g., tiles) affixed to a planar expanse 609 of a panel housing 612, for example, with adhesive. Each sub-piece of the decorative face may be separated by grout. This arrangement may be particularly advantageous when any one of the front panels described herein is installed in a kitchen having a tiled backsplash. Decorative face 614 may be configured to match a tiling of the tiled backsplash such that the panel and backsplash are substantially similar in appearance. In some examples, portions of decorative face 614 may extend past a peripheral panel lip 607 of panel housing 612 to mate with tiles of the tiled backsplash such that portions of the front panel are nearly indistinguishable from portions of the backsplash. For example, one or more edges of face 114 may be castellated and/or otherwise configured to interdigitate or interlock with edges of the surrounding wall.

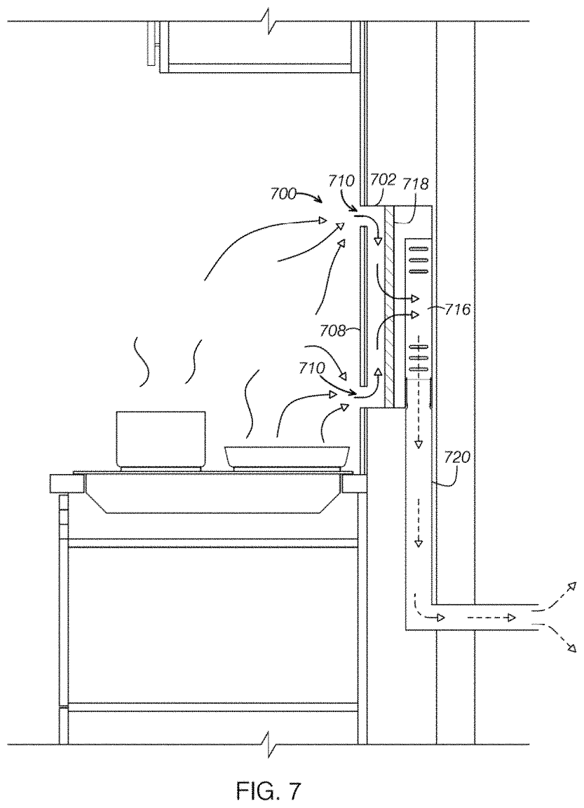

Turning to FIGS. 7-10, the ventilation systems described herein may be configured to exhaust air externally. In these embodiments, the ventilation systems further comprise a blower, a filter system, and ductwork. The blower is configured to draw air into the housing through a gap (e.g., gap 110, 210, 310, etc.), and further draw the air through the filter system. The filter system may comprise a single filter or a plurality of filters of similar or differing material. The filter system may include paper products, polypropylene, activated carbon, polyurethane, polyester, metal, and/or another suitable air filtering material. Additionally, or alternatively, the filter system may include electrostatic filtration. The air is then directed through the ductwork to an external exhaust vent (not shown).

In the example depicted in FIG. 7, blower 716 is disposed within housing 702, and filter system 718 is similarly disposed therein. Filter system 718 is shown vertically aligned and parallel with front panel 708, disposed entirely across housing 702, and positioned in between the front panel and blower 716. In this example, gap 710 is disposed at least at the top and bottom of front panel 708 and blower 716 is configured to draw in air from all portions of gap 710. The air is then directed through filter system 718, thereby removing particulates from the air before being pulled into blower 716.

After filtering, the air is directed into ductwork 720. Ductwork 720 may be disposed within the wall, concealed from the view of a user. The filtered air is moved by the blower through the ductwork to the external vent. In some examples, ductwork 120 may be insulated, e.g., with a fire-retardant material.

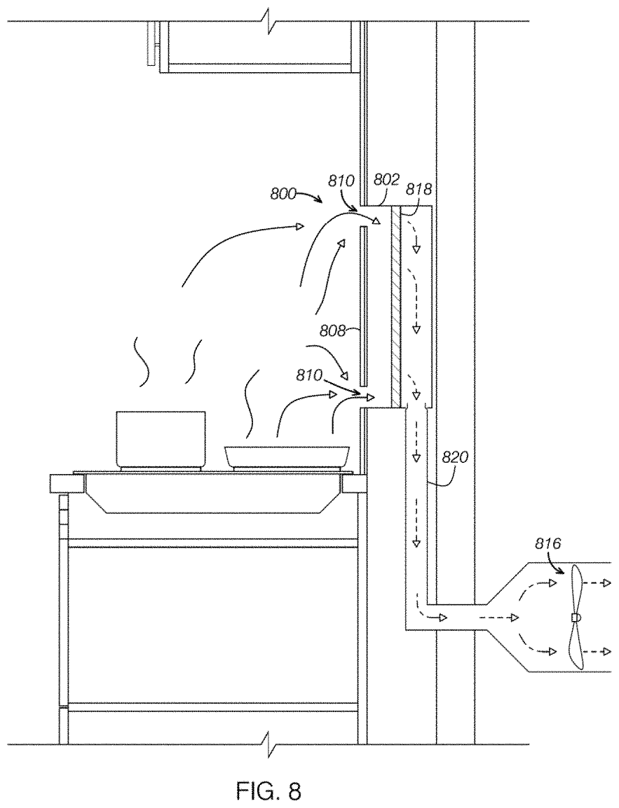

FIG. 8 depicts ventilation system 800 in an externally exhausting configuration. Front panel 808 and filter system 818 are arranged similar to ventilation system 700, described above. Blower 816 is shown disposed within ductwork 820 instead of within housing 802. This configuration enables housing 802 to be smaller than in the example of ventilation system 700, e.g., if ventilation system 800 is to be installed in a narrow or thin wall.

In this example, blower 818 draws air in through gap 810, then filter system 818, and finally through portions of ductwork 820 before passing through the blower. This arrangement enables hot air to cool as it passes through the ductwork before contacting the blower, thereby protecting the blower from high temperatures. The blower then directs the air to the external vent.

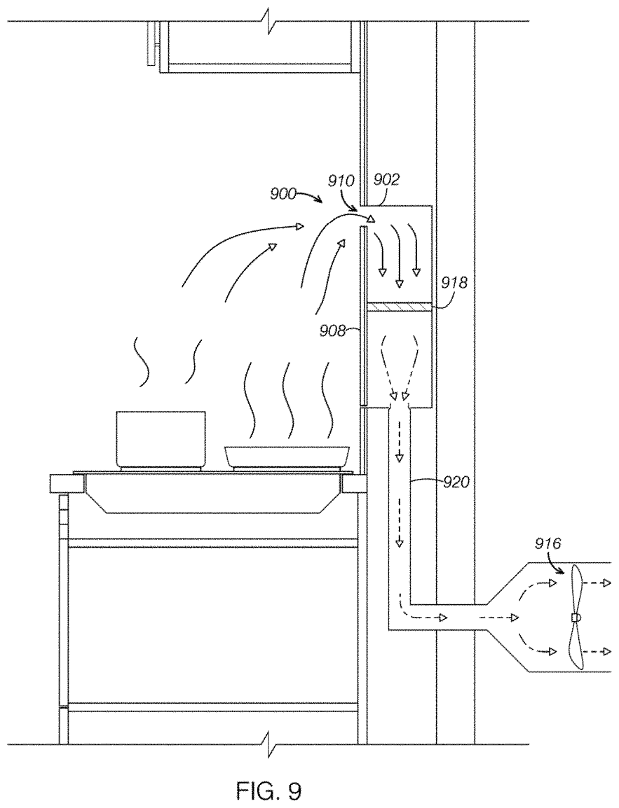

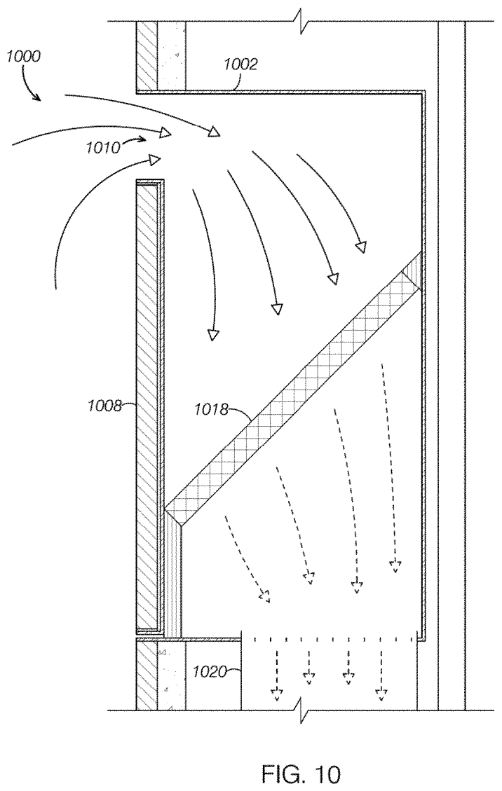

In the examples depicted in FIGS. 9 and 10, front panels 908 and 1008 are configured such that gaps 910 and 1010 are only present between the tops of front panels 908 and 1008 and housings 902 and 1002, respectively, therefore air is restricted to enter housings 902 and 1002 from the top. Accordingly, filter system 918 may be disposed orthogonal to front panel 908 (e.g., in FIG. 9), and filter system 1018 may be disposed diagonal to front panel 1008 (e.g., in FIG. 10). This arrangement enables filter systems 918 and 1018 to be smaller than the previous examples described above, therefore requiring less material and cost. Blower 918 may be disposed within ductwork 920.

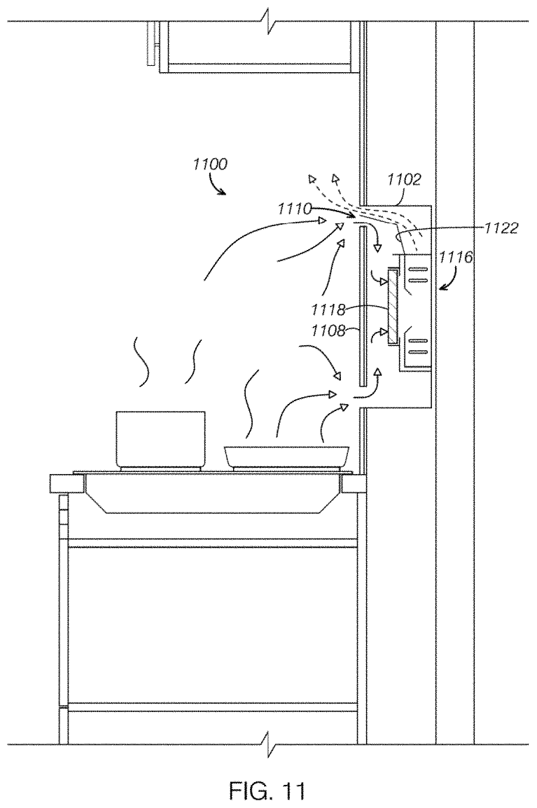

Turning to FIGS. 11-14, the ventilation systems described herein may be configured to recirculate the air back into the kitchen after filtering. In some examples, the air may be exhausted from the housing through the same portion of the gap from which the air is drawn. In other examples, the air may be redirected through a different portion of the gap, or directed through ductwork to another portion of the kitchen.

In the example shown in FIG. 11, front panel 1108 of ventilation system 1100 may be configured such that gap 1110 is present at least at the top and the bottom. Blower 1116 is disposed within housing 1102 with filter system 1118 disposed directly at an air intake of the blower. Blower 1116 may draw air in from any portion of gap 1110 and through filter system 1118. In this example, there is additionally a baffle plate 1122 disposed proximate an exhaust of blower 1116. Baffle plate 1122 is configured to direct the air from the exhaust of blower 1116 toward a portion of gap 1110 (e.g., at the top of the front panel). The air exhausting from gap 1110 may provide an air-curtain effect as air discharging from the top of ventilation system 1100 creates a barrier for ambient air in the kitchen, particularly ambient air directly above the cooktop. The air-curtain effect may prevent air contaminated from cooking from escaping upward, past the exhausting air. Additionally, this arrangement may encourage the intake of air into ventilation system 1100 by restricting the air to the region proximate gap 1110.

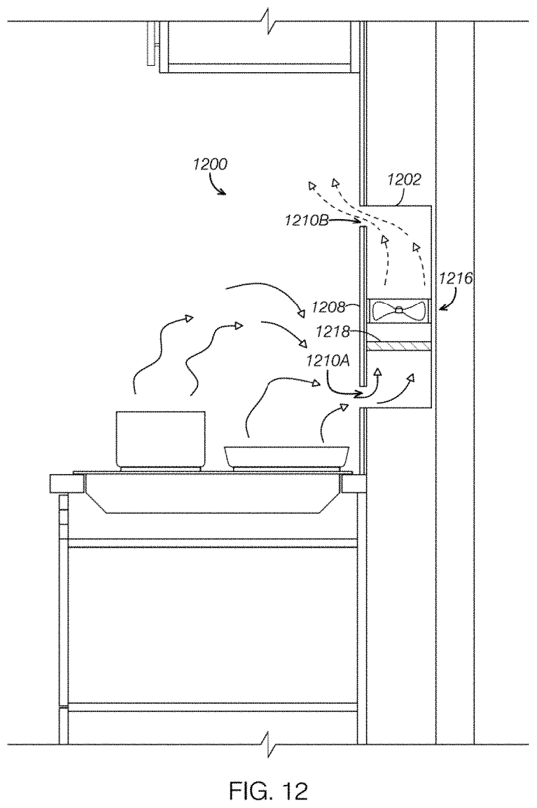

In the example shown in FIG. 12, air is drawn into housing 1202 of ventilation system 1200 through gap 1210A positioned at the bottom of front panel 1208 by blower 1216. Filter system 1218 may be disposed generally orthogonal to front panel 1208 below the blower. Air is drawn through filter system 1218 and directed upward, toward gap 1210B.

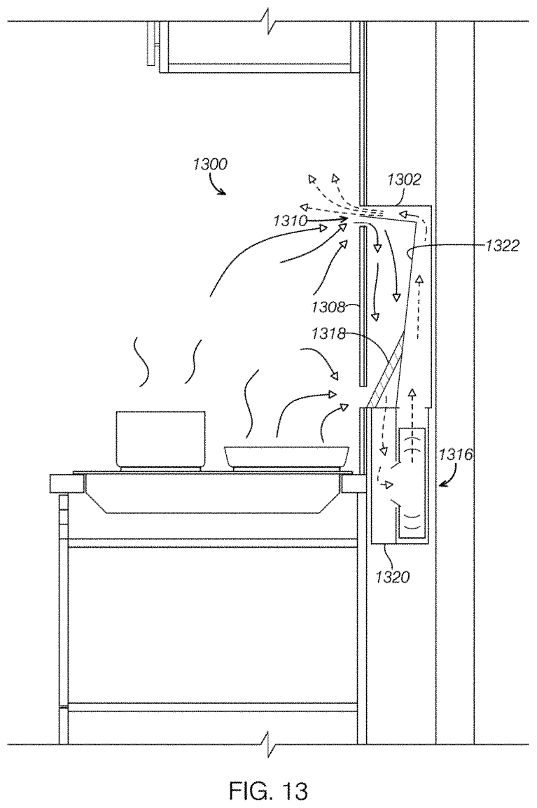

FIG. 13 depicts ventilation system 1300 having a recirculating configuration. In this example, gap 1310 may be present at least at the top and the bottom of front panel 1308. Blower 1316 is configured to draw air in from all portions of gap 1310 and direct the air generally downward through filter system 1318. In this example, blower 1316 is disposed within ductwork 1320, below housing 1302. Similar to ventilation system 1100, baffle plate 1322 is disposed proximate the exhaust of blower 1316 and configured to direct the air out of the top portion of gap 1310. This configuration may additionally create an air-curtain as described above.

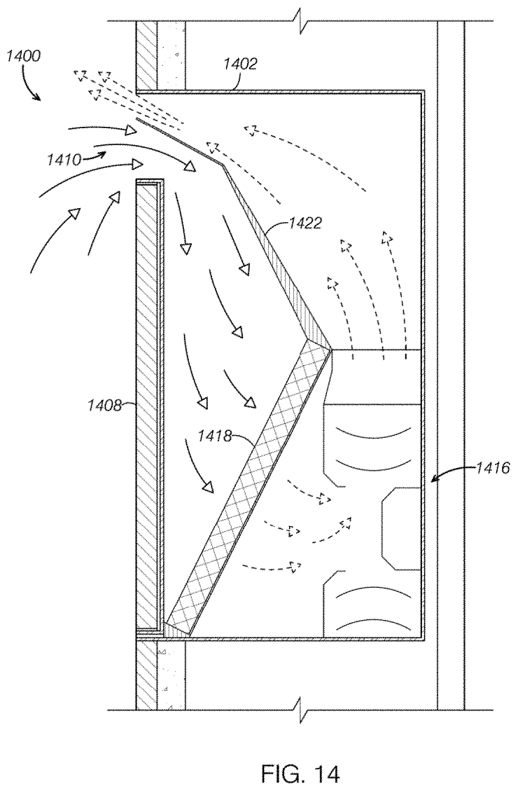

Ventilation system 1400 having a recirculation configuration is depicted in FIG. 14. In this example, gap 1410 is only present at the top of front panel 1408 and blower 1416 is disposed within housing 1402. The top portion of gap 1410 and the bottom portion of gap 1410 are separated from each other (i.e., partitioned) by an angled baffle plate 1422. Intake air is drawn in through the bottom portion of gap 1410 by blower 1416. The intake air then passes through filter system 1418. After filtering, the air is directed by baffle plate 1422 and exhausted through the top portion of gap 1410. In other words, the intake and the exhaust of ventilation system 1400 both occur through the same gap or opening between the panel and the wall. Exhausted air passing through the top portion of the gap entrains ambient air above gap 1410 to create an air-curtain, such that contaminated intake air is prevented from escaping upwards past gap 1410, and instead encouraged into the bottom portion of gap 1410.

As shown by the examples of FIGS. 7-10 and FIGS. 11-14, many advantageous configurations of a ventilation system may be utilized in the present disclosure, some providing different advantages than others.

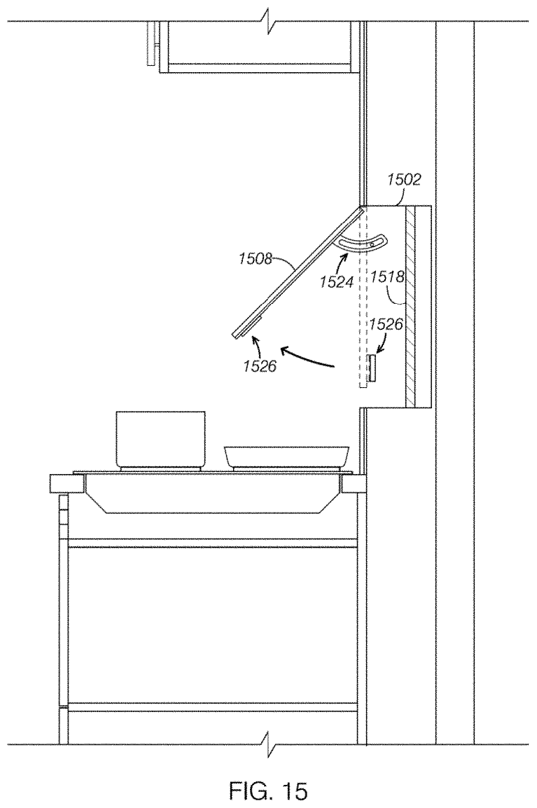

Turning now to FIGS. 15-17, all of the front panels described herein are configured to be positionable or removable, such that the filter system may be accessed by the user, e.g., to replace a filter. The front panels may be configured to pivot up, pivot down, or pivot to the side using a hinge. A latching system is utilized in some examples to secure the panel in place while closed.

In some examples, the front panel may be attached to a telescoping system to allow removal or, alternatively, the front panel may be attached to the ventilation system via a press-to-latch/press-to-release fastening system. Other methods of attaching and latching the front panel may be utilized.

In the example depicted in FIG. 15, front panel 1508 is configured to pivot upwards about a rotational axis defined by hinge 1524. Latching system 1526 is utilized to secure front panel 1508 while the front panel is closed. Latching system 1526 may be magnetic and/or mechanical. To access the interior of housing 1502 and filter system 1518 therein, the user disengages latching system 1526 and pivots front panel 1508 upwards. To close the panel, the user manually rotates the panel downwards until latching system 1526 engages and the panel is shut and flush with the wall.

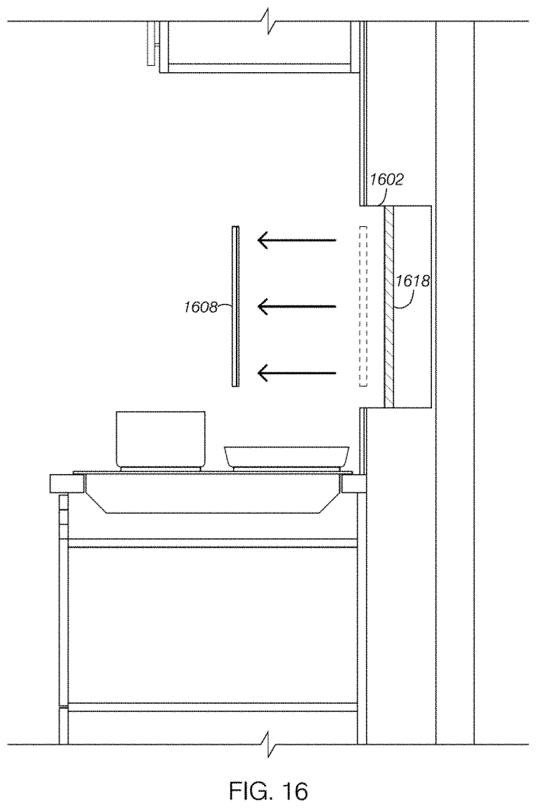

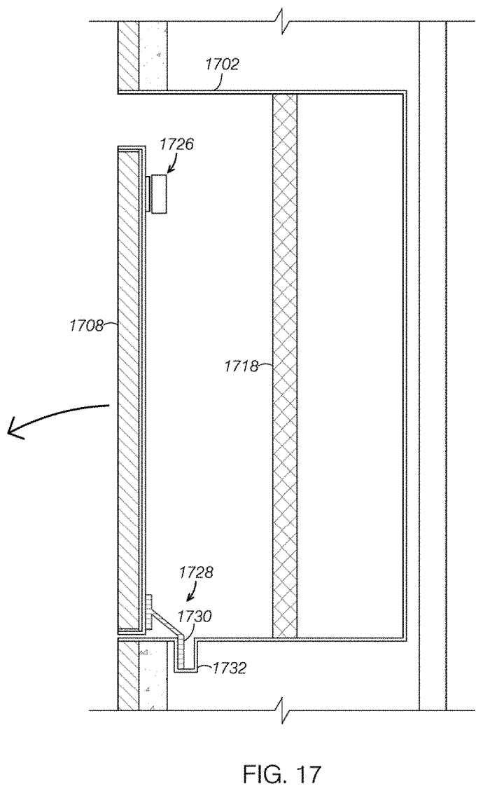

FIGS. 16 and 17 depict examples wherein the front panel is removable. As shown in FIG. 16, front panel 1608 may be configured to pull directly out from housing 1602. For example, front panel 1608 may be friction fitted with housing 1602, such that the user may simply pull the front panel out to access filter system 1618 and similarly push the panel back into place, until the panel is fully inserted and flush with the wall. This example may be configured to utilize a latching system (e.g., latching system 1526) for additional securement.

In the example depicted in FIG. 17, front panel 1708 is configured to pivot forward a specified amount before a user can remove the front panel from housing 1702. This example utilizes latching system 1726 and a peg hinge 1728. Peg hinge 1728 comprises a peg 1730 configured to sit within a recess 1732 in housing 1702. Peg hinge 1728 may be configured such that, in response to the user rotating front panel 1708 outward, peg 1730 tilts and moves rearward within recess 1732, thereby displacing front panel 1708 in a downward direction. This displacement, in concert with the outward rotation of the front panel, disengages latching mechanism 1726 and enables peg 1730 to be removed from recess 1732. Accordingly, front panel 1708 may then be removed from housing 1702 and filter system 1718 may be accessed. To close front panel 1708, the user places peg 1730 into recess 1732 and rotates the front panel until latching mechanism 1726 engages and the front panel is flush with the wall.

In some examples, ventilation systems described herein utilize electronics (e.g., processing logic and/or sensors disposed at least partially within the housing) to monitor and/or control aspects of the filter system. For example, a timer may be included which can be reset by the user when a filter of the filter system is replaced. In some examples, an air flow sensor is configured to measure the air flow of the ventilation system. Data from the timer and/or the air flow sensor may be displayed on a user interface. The user interface may comprise one or more buttons and/or touch controls. The user interface may be incorporated into the front panel or incorporated in other accessible portions of the ventilation system (e.g., within the housing), or may be incorporated into a display of a mobile digital device associated with the user.

In some examples, the blower is controllable by a switch disposed outside of the housing (e.g., on the kitchen wall), or controllable by a portion of the user interface. In some examples, the blower is automatically controlled in response to signals from the cooktop and/or from external sensors built into an appliance in the kitchen. Portions of the ventilation system (e.g., the blower, the latching mechanism, etc.) may be controlled remotely, e.g., via an external data processing system such as a smartphone or a computer.

Aspects of the ventilation system (e.g., a controller and/or monitoring system) may be embodied as a computer method, computer system, or computer program product. Accordingly, aspects of the ventilation system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the ventilation system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the ventilation system may be written in one or any combination of programming languages, including an object-oriented programming language (such as Java, C++), conventional procedural programming languages (such as C), and functional programming languages (such as Haskell). Mobile apps may be developed using any suitable language, including those previously mentioned, as well as Objective-C, Swift, C #, HTMLS, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the ventilation system may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally, or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the ventilation system. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### B. Illustrative Combinations and Additional Examples

This section describes additional aspects and features of a ventilation system in accordance with the present disclosure, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A kitchen ventilation system, comprising:

an opening in a wall;

a removable panel disposed within an inner perimeter of the opening, such that at least one airflow gap is formed between an outer perimeter of the panel and the inner perimeter of the opening; and

a fan in fluid communication with the opening in the wall, wherein the fan is configured to move air through the at least one airflow gap;

wherein the removable panel comprises a planar expanse and a raised lip around the outer perimeter, such that the panel is configured to hold one or more first wall covering materials secured thereon.

A1. The kitchen ventilation system of paragraph A0, further comprising:

one or more second wall covering materials disposed on the wall;

wherein the first and second wall covering materials have a matching appearance.

A2. The kitchen ventilation system of any one of paragraphs A0 or A1, wherein a front face of the removable panel is flush with the wall when installed.

A3. The kitchen ventilation system of any one of paragraphs A0 through A2, wherein the at least one airflow gap is formed continuously around all edges of the removable panel.

A4. The kitchen ventilation system of any one of paragraphs A0 through A3, wherein the at least one airflow gap consists of a single gap along one edge of the removable panel.

A5. The kitchen ventilation system of any one of paragraphs A0 through A4, wherein the single gap is utilized by the fan as an air intake.

A6. The kitchen ventilation system of paragraph A5, wherein the single gap is additionally utilized by the fan as an air exhaust.

A7. The kitchen ventilation system of any one of paragraphs A0 through A6, wherein the at least one airflow gap consists of a first gap along a first edge of the removable panel and a second gap along an opposing second edge of the removable panel.

A8. The kitchen ventilation system of paragraph A7, wherein the first gap is utilized by the fan as an air intake.

A9. The kitchen ventilation system of paragraph A8, wherein the second gap is utilized by the fan as an air exhaust.

A10. The kitchen ventilation system of any one of paragraphs A0 through A9, wherein the inner perimeter of the wall opening and the outer perimeter of the removable panel each have a rectilinear shape.

A11. The kitchen ventilation system of any one of paragraphs A0 through A10, wherein the wall is part of a room in a building, and the fan is configured to cause the air to exhaust to an exterior of the building.

A12. The kitchen ventilation system of any one of paragraphs A0 through A11, further comprising one or more filters disposed in an airflow path of the fan.

A13. The kitchen ventilation system of any one of paragraphs A0 through Al2, wherein the at least one airflow gap has a dimension no larger than 25% of a width of the removable panel.

A14. The kitchen ventilation system of any one of paragraphs A0 through A13, wherein the at least one airflow gap has a dimension between 0.25 inches and 6 inches.

A15. The kitchen ventilation system of any one of paragraphs A0 through A14, further comprising a housing;

wherein the removable panel is rotatably attached to the housing via a hinge.

A16. The kitchen ventilation system of paragraph A15, further comprising a latching mechanism;

wherein the latching mechanism secures the removable panel to the housing when the removable panel is installed.

A17. The kitchen ventilation system of paragraph A16, wherein the latching mechanism is magnetic.

A18. The kitchen ventilation system of any one of paragraphs A0 through A17, further comprising a filter.

A19. The kitchen ventilation system of paragraph A18, wherein the filter comprises at least one material from the group consisting of: paper, polypropylene, activated carbon, polyurethane, polyester, and metal.

### Advantages, Features, and Benefits

The different embodiments and examples of the ventilation system described herein provide several advantages over known solutions for providing a kitchen ventilation system hidden e.g., within a wall. For example, illustrative embodiments and examples described herein allow a near seamless transition between a kitchen backsplash and a ventilation system.

Additionally, and among other benefits, illustrative embodiments and examples described herein remove the need for a soffit, cabinetry, or other structure used to house a ventilation system to occupy the space above a cooktop.

Additionally, and among other benefits, illustrative embodiments and examples described herein allow up-to-date monitoring of air filter health.

Additionally, and among other benefits, illustrative embodiments and examples described herein allow more accessibility to the air filtration system.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A kitchen ventilation system, comprising:
an opening in a wall;
a removable panel disposed within an inner perimeter of the opening, such that at least one airflow gap is formed between an outer perimeter of the panel and the inner perimeter of the opening; and
a fan in fluid communication with the opening in the wall, wherein the fan is configured to move air through the at least one airflow gap;
wherein the removable panel comprises a planar expanse and a raised lip around the outer perimeter, such that the panel is configured to hold one or more first wall covering materials secured thereon.

2. The kitchen ventilation system of claim 1, further comprising:
one or more second wall covering materials disposed on the wall;
wherein the first and second wall covering materials have a matching appearance.

3. The kitchen ventilation system of claim 1, wherein a front face of the removable panel is flush with the wall when installed.

4. The kitchen ventilation system of claim 1, wherein the at least one airflow gap is formed continuously around all edges of the removable panel.

5. The kitchen ventilation system of claim 1, wherein the at least one airflow gap consists of a single gap along one edge of the removable panel.

6. The kitchen ventilation system of claim 1, wherein the single gap is utilized by the fan as an air intake.

7. The kitchen ventilation system of claim 6, wherein the single gap is additionally utilized by the fan as an air exhaust.

8. The kitchen ventilation system of claim 1, wherein the at least one airflow gap consists of a first gap along a first edge of the removable panel and a second gap along an opposing second edge of the removable panel.

9. The kitchen ventilation system of claim 8, wherein the first gap is utilized by the fan as an air intake.

10. The kitchen ventilation system of claim 9, wherein the second gap is utilized by the fan as an air exhaust.

11. The kitchen ventilation system of claim 1, wherein the inner perimeter of the wall opening and the outer perimeter of the removable panel each have a rectilinear shape.

12. The kitchen ventilation system of claim 1, wherein the wall is part of a room in a building, and the fan is configured to cause the air to exhaust to an exterior of the building.

13. The kitchen ventilation system of claim 1, further comprising one or more filters disposed in an airflow path of the fan.

14. The kitchen ventilation system of claim 1, wherein the at least one airflow gap has a dimension no larger than 25% of a width of the removable panel. 15, The kitchen ventilation system of claim 1, wherein the at least one airflow gap has a dimension between 0.25 inches and 6 inches.

16. The kitchen ventilation system of claim 1, further comprising a housing;
wherein the removable panel is rotatably attached to the housing via a hinge.

17. The kitchen ventilation system of claim 16, further comprising a latching mechanism;
wherein the latching mechanism secures the removable panel to the housing when the removable panel is installed.

18. The kitchen ventilation system of claim 17, wherein the latching mechanism is magnetic.

19. The kitchen ventilation system of claim 1, further comprising a filter.

20. The kitchen ventilation system of claim 19, wherein the filter comprises at least one material from the group consisting of: paper, polypropylene, activated carbon, polyurethane, polyester, and metal.
